(19) United States
(12) Patent Application Publication
(10) Pub. No.: US 2007/0236956 A1
(43) Pub. Date: Oct. 11, 2007

(54) Super bright LED power package

(75) Inventors: Boris Kolodin, Beachwood, OH (US); Shawn Xiaofeng Du, Macedonia, OH (US); Emil Radkov, Euclid, OH (US); Mark J. Mayer, Sagamore Hills, OH (US); Ivan Eliashevich, Maplewood, NJ (US)

Correspondence Address: Scott A. McCollister, Esq.;Fay, Sharpe, Fagan, Minnich & McKee, LLP, Seventh Floor, 1100 Superior Avenue, Cleveland, OH, 44114-2579, US

(73) Assignee: GELcore, LLC

(21) Appl. No.: 11/394,895

(22) Filed: Mar. 31, 2006

(51) Int. Cl. G02B 6/00; F21V 9/00

(52) U.S. Cl. 362/555; 362/554; 362/556

(57) ABSTRACT

At least two light emitting diodes emit a non-parallel light beam. A condensing system, operationally coupled with the light emitting diodes, receives the emitted non-parallel light beam and converts the received non-parallel light beam into a parallel light beam. A non-imaging concentrator includes an input surface which collects the parallel light beam, and an output surface, which includes phosphor material and outputs light.

### BACKGROUND

The present exemplary embodiment relates to the lighting arts. It finds particular application in conjunction with a spot module light source for automotive applications, and will be described with particular reference thereto. However, it is to be appreciated that the present exemplary embodiment is also amenable to other like applications.

Current spot module lamp technology relies primarily on halogen-type lamps. The use of halogen-type lamps for spot lighting, however, has some drawbacks. For example, excessive heating can limit the usage of these types of lamps for commercial and consumer applications. The efforts have been made to replace the halogen lamp with the white LED power package lamp. Typically, a power package light emitting diode (LED) lamp includes an LED coupled to a heatsink. The light-emitting diode die can be mounted directly or indirectly via; for example, a thermally conducting sub-mount to the heatsink. An optical lens is added by mounting a pre-molded thermoplastic lens and an encapsulant. Typically, the package also includes a reflector cup. The LED is coated with the phosphor to produce white light. However, several LED power packages are required to replace the halogen-type lamp, for example, in the automotive headlamp. The presence of the lens in the package results in the overall increase of the dimensions of the LED lamp.

An alternative solution is to use a super bright LED lamp which includes a single LED which is coated with a phosphor layer by a use of transfer molding process. In such system, an embedded lens is omitted from the package. However, the single LED does not produce enough light for the automotive headlight. In addition, the phosphor coating in this solution is disposed directly on the LED die surface, causing heating of the phosphor and resulting in decrease in performance, as well as potential reliability issues.

The present application provides new and improved apparatuses and methods which overcome the above-referenced problems and others.

### BRIEF DESCRIPTION

In accordance with one aspect, a lighting system is disclosed. At least two light emitting diodes emit a non-parallel light beam. A condensing system, operationally coupled with the light emitting diodes, receives the emitted non-parallel light beam and converts the received non-parallel light beam into a parallel light beam. A non-imaging concentrator includes an input surface which collects the parallel light beam, and an output surface, which includes a phosphor material and outputs light.

In accordance with another aspect, a light emitting diode spot lamp is disclosed. Light emitting diodes emit a non-parallel light beam. A lens system receives the emitted non-parallel light beam and converts the received non-parallel light beam into a parallel light beam. A non-imaging concentrator includes an input surface which collects the parallel light beam, and an output surface including a phosphor material which output surface produces a point like light.

In accordance with another aspect, a light emitting diode lighting system for a use in an automotive headlamp is disclosed. Light emitting diodes are disposed on a mounting surface to emit a non-parallel light beam. A condensing system receives the emitted non-parallel light beam and converts the received non-parallel light beam into a parallel light beam. An optical taper includes a light input surface which collects the parallel light beam, a taper volume which includes optical fibers which guide and reduce a cross-section of the collected parallel light beam, and a light output surface including a phosphor material which light output surface produces a light of the reduced cross-section.

### BRIEF DESCRIPTION OF THE DRAWINGS

FIG. 1 is a graphical representation of the LED lighting system.

### DETAILED DESCRIPTION

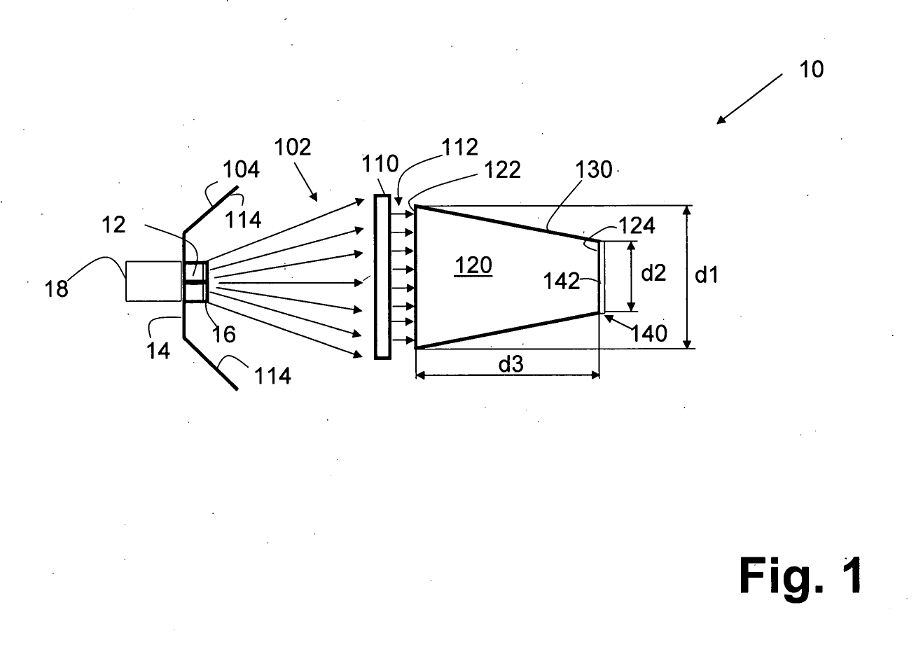

With reference to FIG. 1, a lighting system 10 includes light emitting diodes (LEDs) or light emitting diode dies 12 disposed on a mounting surface 14. The mounting surface 14 may comprise sapphire, silicon, silicon carbide, ceramics, polyimide, and other like materials. The light emitting diode dies 12 may be mounted to the mounting surface 14 via any appropriate method for adhesion known in the art, including using low temperature melting waxes, aqueous or solventable waxes, thermoplastics, UV or thermal epoxies, polyimides or acrylics, bonding pads and the like appropriate methods and materials. Alternatively, the mounting surface 14 may be a device such as a driver or circuit board having connection or bond pads arranged to cooperatively match connection or bond pads of the LED dies 12 to provide what is known as a flip chip arrangement. Optionally, each LED die 12 includes a layer of an index matching material 16. The index matching material 16 preferably has a refractive index substantially equal to or greater than the refractive index of the region of the die which abuts such material. Examples of the index matching material 16 are polymer, epoxy, silicone and glass. In one embodiment, the index matching material 16 is shaped as a semi-spherical or nearly semi-spherical lens. In another embodiment, the index matching material 16 is a flat layer. A heatsink 18 is disposed adjacently the mounting surface 14 in thermal communication with the LEDs 12. Because the LED dies 12 are thermally coupled to the heatsink 18, the LED dies 12 can be maintained at a lower operating temperature.

With continuing reference to FIG. 1, the light emitting diodes 12 emit a non-parallel light beam 102. Although only two light emitting diodes 12 are illustrated, it is contemplated that a number of the light emitting diodes 12 may be three, four, and the like. An optional reflector 104 reflects the emitted light onto a condensing system 110, such as a condensing lens system, which is fabricated, for example, from a plastic material. The condensing system 110 receives the emitted non-parallel light beam 102, that comes from a large angular spread, and converts the received non-parallel light beam 102 into a substantially parallel or collimated light beam 112 of a cross-section that is smaller than a cross-section of the non-parallel light beam 102. The examples of the condensing or lens system 110 are a fresnel lens system, fresnel zone plates, a convex lens system, a double convex lens system, and the like.

In one embodiment, the lens system 110 is a microlens system which is manufactured directly on the light emitting diode die 12. This results in substantially minimized optical coupling losses.

The reflector 104 may be made of thermally conductive materials that have been plated for reflectivity. Suitable thermally conductive materials, from which the reflector may be composed, include materials such as silver, copper, aluminum, molybdenum, diamond, silicon, aluminum nitride, aluminum oxide, beryllium oxide, boron nitride, and composites thereof. Reflector walls 114 may also be made of thermally insulating materials, e.g. plastics with reflective coatings.

A non-imaging concentrator 120 receives the parallel light beam 112 at a light input surface 122 and outputs the light beam at a light output surface 124. The output surface 124 of the non-imaging concentrator 120 is substantially smaller than the input surface 122 of the non-imaging concentrator 120. The collimated light 112 enters the larger light input surface 122, travels within the non-imaging concentrator 120 constrained by non-imaging concentrator side surface or surfaces 130, and exits at a smaller non-imaging concentrator light output 124. For example, the input surface 122 is a square with a side d1 which is equal to about 6 mm or a circle with a diameter which is equal to about 6 mm, and the output surface 124 is a square with a side d2 which is equal to about 1 mm or a circle with a diameter which is equal to about 1 mm. In this embodiment, a light output to light input ratio is about 1 to 6 or smaller. A length d3 of the non-imaging concentrator 120 is smaller than or equal to about 5 mm. The non-imaging concentrator 120, for example, is fabricated from a plastic material.

In one embodiment, the non-imaging concentrator 120 is one of a regular and an irregular taper which includes fibers disposed within the volume constrained by the light input, light output and taper side surfaces 122, 124, 130 of the non-imaging concentrator 120. More specifically, the regular taper is an optical taper which includes fibers disposed sequentially. The irregular taper includes fibers which are disposed randomly. Optical fibre or fiber is typically a thin (typically 125 micron diameter) continuous silica cylinder consisting of a central region (the core) typically 10 microns in diameter surrounded by a cladding. Both core and cladding are mainly silica, and the core is doped with germanium in order to raise its refractive index above that of the cladding and so allow it to guide light with overall very little losses. In another embodiment, the non-imaging concentrator 120 includes SELFOC lens or optical system which is a self-focusing lens manufactured and distributed by NSG Europe. Unlike the conventional lens, where rays of light change direction at the interface of the lens and air, the index of refraction in the SELFOC lens is controllably varied within the lens material. This is achieved by a high-temperature ion exchange process within the lens material. Since the index of refraction is gradually varied within the lens material, light rays can be smoothly and continually redirected towards a point of focus, resulting in compact lens geometry.

The non-imaging concentrator light output surface 124 includes a layer 140 including phosphor or phosphor material 142 to convert the light emitted by the light emitting diodes 12 into an ultra bright light. In one embodiment, the non-imaging concentrator output surface 124 is coated with a luminescent phosphor conversion material (a single phosphor or a phosphor blend). The phosphor materials presented in this embodiment emit ultra bright light when excited by radiation from about 250 nm to about 550 nm as emitted by a near UV to green LED. The light output of the lighting system 10 is driven by the efficacy of both the LED 12 and phosphors used.

The relative amounts of each phosphor in the phosphor material can be described in terms of spectral weight. The spectral weight is the relative amount that each phosphor contributes to the overall emission spectrum of the phosphor material, as necessary to achieve the desired color of the light emitted by the package. The spectral weight amounts of all the individual phosphors should add up to unity. In one embodiment, a phosphor material comprises a spectral weight of from about 0 to about 0.50 of an optional phosphor with an emission maximum from about 430 nm to about 500 nm (which would not be needed for excitation with a blue or blue-green LED having an emission maximum from about 430 nm to about 500 nm), and the balance of the material being a phosphor with an emission maximum from about 500 nm to about 610 nm, to produce white light. Garnets activated with at least Ce³⁺, such as yttrium aluminum garnet (YAG:Ce), terbium aluminum garnet (TAG:Ce) arid appropriate compositional modifications thereof known in the art, are particularly preferred phosphors with an emission maximum from about 500 nm to about 610 nm. In another embodiment, other phosphors with an emission maximum from about 500 nm to about 610 nm are alkaline earth orthosilicates activated with at least Eu²⁺, e.g. (Ba,Sr,Ca)₂SiO₄: Eu²⁺ (“BOS”) and appropriate compositional modifications thereof known in the art.

It is contemplated that various phosphors which are described in this application in which different elements enclosed in parentheses and separated by commas, such as (Ba,Sr,Ca)₂SiO₄: Eu²⁺ can include any or all of those specified elements in the formulation in any ratio. For example, the phosphor identified above has the same meaning as (BaₐSr_{b}Ca_{1-a-b})₂SiO₄: Eu²⁺, where a and b can each vary such that the total value of a and b may assume values from 0 to 1, including the values of 0 and 1.

Depending on the identity of the specific phosphors, exemplary lighting system 10, for example, produces white light having general color rendering index (Rₐ) values greater than 70, preferably >80, and correlated color temperature (CCT) values less than 6500K.

In addition, other phosphors emitting throughout the visible spectrum region, may be used in the phosphor material to customize the color of the resulting light and produce sources with improved light quality. While not intended to be limiting, suitable phosphors for use in the blend with the present phosphors include:
(Ba,Sr,Ca,Zn)₅(PO₄)₃(Cl,F,Br,OH):Eu²⁺ (SECA)
(Ba,Sr,Ca)BPO₅:Eu²⁺
(Sr,Ca)₁₀(PO₄)₆*νB₂O₃:Eu²⁺ (wherein 0<ν≦1)
Sr₂Si₃O₈*2SrCl₂: Eu²⁺
(Ca,Sr,Ba)₃MgSi₂O₈:Eu²⁺
BaAl₈O₁₃:Eu²⁺
2SrO*0.84P₂O₅*0.16B₂O₃:Eu²⁺
(Ba,Sr,Ca)MgAl₁₀O₁₇:Eu²⁺ (BAM)
(Ba,Sr,Ca)Al₂O₄:Eu²⁺
(Ba,Sr,Ca)₂Si_{1-ξ}O_{4-2ξ}:Eu²⁺ (wherein 0≦ξ≦0.2)
(Ba,Sr,Ca)₂(Mg,Zn)Si₂O₇:Eu²⁺
(Sr,Ca,Ba)(Al,Ga,In)₂S₄:Eu²⁺
(Y,Gd,Tb,La,Sm,Pr,Lu)₃(Sc,Al,Ga)_{5-α}O_{12-3/2α}:Ce³⁺ (wherein 0≦α≦0.5)
(Lu,Sc,Y,Tb)₂₋ᵤ₋ᵥCeᵥCa₁₊ᵤLi_{w}Mg_{2-w}P_{w}(Si,Ge)_{3-w}O_{12-u/2} (wherein −0.5≦u≦1; 0<v≦0.1; and
0≦w≦0.2)
(Ca,Sr)₈(Mg,Zn)(SiO₄)₄Cl₂: Eu²⁺
(Sr,Ca,Ba,Mg,Zn)₂P₂O₇:Eu²⁺
(Ca,Sr)S:Eu²⁺,Ce³⁺
SrY₂S₄:Eu²⁺
CaLa₂S₄:Ce³⁺
(Ba,Sr,Ca)MgP₂O₇:Eu²⁺
(Ba,Sr,Ca)_{β}Si_{γ}N_{μ}:Eu²⁺ (wherein 2β+4γ=3μ)
Ca₃(SiO₄)Cl₂:Eu²⁺
(Y,Lu,Gd)_{2-φ}Ca_{φ}Si₄N_{6+φ}C_{1-φ}:Ce³⁺ (wherein 0≦φ≦0.5)
(Lu,Ca,Li,Mg,Y)alpha-SiAlON: Eu²⁺, Ce³⁺
(Ca,Sr,Ba)SiO₂N₂:Eu²⁺, Ce³⁺
3.5MgO*0.5MgF₂*GeO₂:Mn⁴⁺
Ca_{1-c-f}Ce_{c}Eu_{f}Al_{1+c}Si_{1-c}N₃(wherein 0<c≦0.2, 0≦f≦0.2)
Ca₁₋ₕ₋ᵣCeₕEuᵣAl₁₋ₕ(Mg,Zn)ₕSiN₃ (wherein 0<h≦0.2, 0≦r≦0.2)
Ca₁₋₂ₛ₋ₜCeₛ(Li,Na)ₛEuₜAlSiN₃ (wherein 0≦s≦0.2, 0≦f≦0.2, s+t>0)
Ca_{1-σ-χ-φ}Ce_{σ}(Li,Na)_{χ}Eu_{φ}Al_{1+σ-χ}Si_{1-σ+χ}N₃ (wherein 0≦σ≦0.2, 0<χ≦0.4, 0≦φ≦0.2)

It is contemplated that when a phosphor has two or more dopant ions (i.e. those ions following the colon in the above compositions), the phosphor has at least one (but not necessarily all) of those dopant ions within the material. E.g., the phosphor can include any or all of those specified ions as dopants in the formulation.

When the phosphor composition includes a blend of two or more phosphors, the ratio of each of the individual phosphors in the phosphor blend may vary depending on the characteristics of the desired light output. The relative proportions of the individual phosphors in the various phosphor blends may be adjusted to produce visible light of predetermined x and y values on the CIE chromaticity diagram. The produced white light may, for instance, possess an x value in the range of about 0.30 to about 0.55, and a y value in the range of about 0.30 to about 0.55. In the preferred embodiment, the color point of the white light lies on or substantially on the Planckian (also known as the blackbody) locus), e.g. within 0.020 units in the vertical (y) direction of the 1931 CIE chromaticity diagram, more preferably within 0.010 units in the vertical direction. Of course, it is contemplated that the identity and amounts of each phosphor in the phosphor composition can be varied according to the needs of the particular end user. Since the efficiency of individual phosphors may vary widely between suppliers, the exact amounts of each phosphor needed are best determined empirically, e.g. through standard design of experimental (DOE) techniques.

In one embodiment, the color of the white light generated by the embodiments of this application is designed to conform to the standards of the Society of Automotive Engineers (SAE), more specifically SAE Standard J578c, e.g. according to 49 CFR Ch. V (10-1-02 Edition), for use in automobile headlamps.

In one embodiment, the phosphor blend of BOS phosphor and a blue phosphor (e.g. SECA or BAM identified above) provides light conversion from ultraviolet to white light for a group III-nitride light emitting diodes.

In this manner, a point like light source with a 1×1 mm emitting area, which includes phosphor disposed remotely from the LEDs, produces a high efficiency focused ultra bright light. The optical coupling absorption losses are substantially minimized. The heating of the remotely positioned phosphor is also minimized, thus providing a high efficiency uniform bright white light.

The exemplary embodiment has been described with reference to the preferred embodiments. Obviously, modifications and alterations will occur to others upon reading and understanding the preceding detailed description. It is intended that the exemplary embodiment be construed as including all such modifications and alterations insofar as they come within the scope of the appended claims or the equivalents thereof.

1. A lighting system comprising:
at least two light emitting diodes which emit a non-parallel light beam;
a condensing system operationally coupled with the light emitting diodes which receives the emitted non-parallel light beam and converts the received non-parallel light beam into a parallel light beam; and
a non-imaging concentrator including:
an input surface which collects the parallel light beam, and
an output surface, which includes a phosphor material and outputs light.

2. The system as set forth in claim 1, wherein the non-imaging concentrator includes an optical taper including:
a side surface extending from the input to output surface and which, together with the input and output surfaces, defines a taper volume; and
a plurality of fibers disposed within the taper volume.

3. The system as set forth in claim 2, wherein the fibers are one of sequential and randomly positioned fibers.

4. The system as set forth in claim 1, wherein an output to input surface ratio of the non-imaging concentrator is smaller than or equal to 1 to 6.

5. The system as set forth in clam 1, wherein the non-imaging concentrator includes a SELFOC optical system.

6. The system as set forth in claim 1, wherein the condensing system and the light emitting diodes comprise an integrated module.

7. The system as set forth in claim 1, wherein the condensing system includes at least one of:
a microlens system;
a fresnel lens system;
a fresnel zone plate system;
a convex lens system; and
a double convex lens system.

8. The system as set forth in claim 1, further including:
at least three light emitting diodes which emit the non-parallel light beam which is received by the condensing system.

9. The system as set forth in claim 1, wherein the phosphor material comprises two or more phosphors.

10. The system as set forth in claim 9, wherein at least one of the phosphors has an emission maximum from about 430 nm to about 500 nm.

11. The system as set forth in claim 9, wherein at least one of the phosphors has an emission maximum from about 500 nm to about 610 nm.

12. The system as set forth in claim 1, wherein the phosphor material includes at least one of a garnet activated with Ce³⁺ and an alkaline earth orthosilicate activated with Eu²⁺.

13. The system as set forth in claim 1, wherein the light, which is outputted at the output surface of the non-imaging concentrator, is white.

14. The system as set forth in claim 13, wherein the white light has a CCT of less than 6500K.

15. The system as set forth in claim 13, wherein the white light has a general CRI (Rₐ) greater than 70.

16. The system as set forth in claim 13, wherein the white light has a general CRI greater than 80.

17. The system as set forth in claim 13, wherein the color point of the white light is within 0.01 from the Planckian locus in the vertical direction on the 1931 CIE chromaticity diagram.

18. The system as set forth in claim 1, further including:
a reflector disposed about the light emitting diodes which reflects the light emitted by the light emitting diodes onto the condensing system.

19. A light emitting diode spot lamp comprising:
light emitting diodes which emit a non-parallel light beam;
a lens system which receives the emitted non-parallel light beam and converts the received non-parallel light beam into a parallel light beam; and
a non-imaging concentrator including:
an input surface which collects the parallel light beam, and
an output surface including phosphor material which output surface produces a point like light.

20. A light emitting diode lighting system for a use in an automotive headlamp comprising:
light emitting diodes disposed on a mounting surface which light emitting diodes emit a non-parallel light beam;
a condensing system which receives the emitted non-parallel light beam and converts the received non-parallel light beam into a parallel light beam; and
an optical taper including:
a light input surface which collects the parallel light beam,
a taper volume which includes optical fibers which guide and reduce a cross-section of the collected parallel light beam, and
a light output surface including phosphor material which light output surface produces a light of the reduced cross-section.
